(19) United States
(12) Patent Application Publication
(10) Pub. No.: US 2007/0219906 A1
(43) Pub. Date: Sep. 20, 2007

(54) METHODS AND APPARATUS FOR SELLING MUSIC USING SCA INFORMATION

(76) Inventor: Nicholas Joseph Thomas, Manchester, MO (US)

Correspondence Address: NICHOLAS J. THOMAS, 2425 HANOVER, COLUMBIA, IL, 62220, US

(21) Appl. No.: 11/678,610

(22) Filed: Feb. 25, 2007

Related U.S. Application Data
(60) Provisional application No. 60/767,004, filed on Feb. 26, 2006.

(51) Int. Cl. H04L 9/00

(52) U.S. Cl. 705/50

(57) ABSTRACT

Method and apparatus for the purchasing of music using SCA data in common radio waves. This invention allows a portable device to record URLs and keywords inputed by the user for retrieval later by a software program capable of running searches on specified servers or placing a purchase using a specific URL.

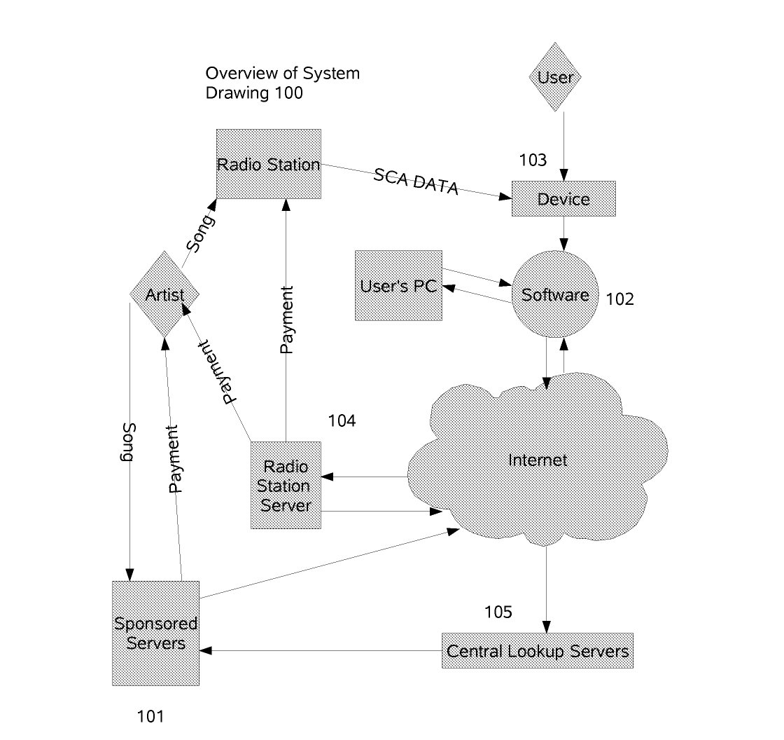

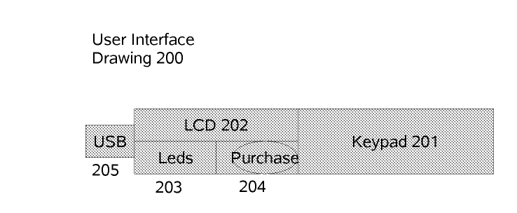

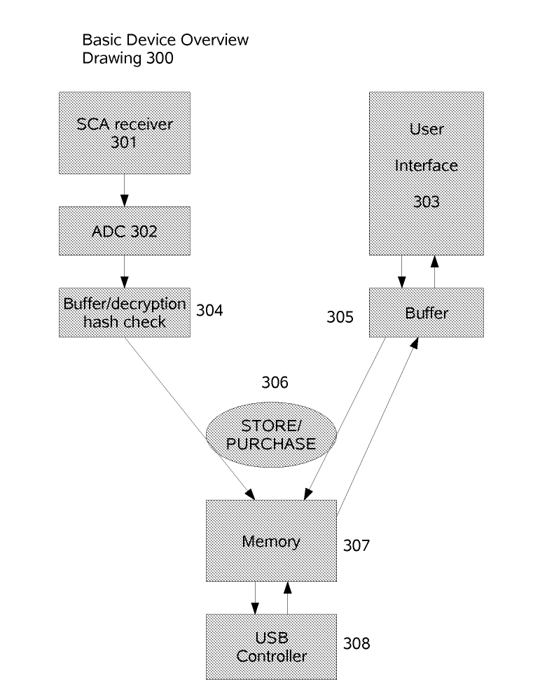

### CROSS REFERENCE TO RELATED APPLICATION

This non-provisional application is to fulfill the filing requirements of the provisional application 60/767,004 filed on Feb. 26, 2006 which is hereby incorporated by reference.

### BACKGROUND OF THE INVENTION

Currently if a band or musician would like to sell their music without the aid of a major marketing corporation, they must rely on small impromptu gatherings or gigs to build a name. There is no direct way a musician has to contact the public in the masses and allow their music to be purchased by anyone that wishes to. The Internet goes a long way in providing a medium to sell their music to the masses but the average musician still lacks a major marketing technique to bring in additional customers.

This Invention allows both radio stations and musicians to sell music and market it to the masses without the aid of any major marketing companies. When a musician is ready to sell to the public they can now contact radio stations directly, however a musician is still unlikely to gain a large amount of funding from just this method as there is no real way of tracking how many listeners would be willing to purchase their music if given the chance. The average listener base is too lazy to look up a website or go to a concert to purchase music. This technology will allow a user to push a button on their radio or a separate hand held device that will allow them to then purchase the song from the Internet at a later date.

SCA sub carrier data is already used for a great variety of reasons by radio stations to make additional funding. While a radio station broadcasts a song, they can use the SCA data to send out a URL for purchasing the song. When the listener likes the music they hear they can simply press a button on the invention that allows them to purchase it. The invention will in turn store the URL to a memory medium.

In addition to the added value of listeners being able to make purchases of new music heard on the radio that may not have had a large enough name before for the listener to purchase their music in their local stores, the invention also provides a method for bands to sell their music at concerts. If the band has no Internet server to sell their music, a company may sponsor them online. At the gig or concert, the band's fans would only have to hear the company's name and the band's name in order to search online later for music to purchase from the company. The fan would simply type in the band's name and the company's name into the invention, store it to the invention's memory, and then use the software coupled with that invention on their home computer to locate the songs they want and make the purchase.

This invention provides a connection between all the many ways we have to purchase music today with our day to day life of hearing music we love. While there are other technologies out there that provide such a service, none are as adaptable or as cheap to all participants as this.

While there have been many different technologies that use SCA data to produce profits for radio stations, none provides the service this invention does while promoting all participants involved in selling the music. For example, US Publication number 20040128514 covers the watermarking of music to track music heard so a user may store the data to purchase the music and purchase it latter. This requires the use of complicated watermarking software and license rights small bands may not have when they are just getting started. The above invention also requires a complicated interpretation of the audio signal to identify watermarks. Separating the purchase information from the audio track and broadcasting it in an SCA channel allows bands to release music to radio stations without the need for expensive watermarking software.

The patent publication 20040128514 also requires a complicated matching system to allow songs received by the player to be identified with an online database. In this invention the purchasing of music by a band can happen in multiple ways, all independent of each other.

If the SCA data provides a URL, the listener may purchase the music directly from that URL. This allows profit from both the radio station and the artist by purchasing through the radio station's website. If there is no SCA data available, the user may still enter keywords to search later.

If the user is at a concert, purchasing the band's music maybe as easy as storing the band's name along with the company name. The user would simply input the names using the keypad, and then store it to the memory device. Once the user returns to their home PC, the data can be used by a program that was shipped with the product that allows searching key servers for the company name or band name. This search will yield a type of profile allowing the download and purchase of the band's music. Either through the band's website, or the company that is sponsoring the band.

In the case that there is no sponsor and no know band website, keywords can be used. A keywords, such as a series of song lyrics or an artist name can be typed into the device. The search program on their home PC will use this data to search major music purchasing websites such as Amazon.com, Itunes, Wal-Mart, and others. Once a website returns with the keywords, the results are displayed to the user so they can fine tune their search if need be.

This invention takes out all the overhead of major marketing involved for bands to make their name huge. It provides the most seamless interaction between a band and their listeners without the need for expensive software tools, marketing companies, or even radio stations to play their music. An artist can hang a sign around their neck with his name, publish their name on one of the central servers the device searches, and anyone may then purchase his/her music. These sales can be used to gain more marketing clout as sales will be tracked for tax purposes. An artist can use the sales of their music as proof that their music is in demand, making radio stations more interested in broadcasting their songs to a wider audience. Once that happens, and a market is shown for the artist's music, even more radio stations may play it to gain more profits.

### BRIEF DESCRIPTION OF THE INVENTION

The system has multiple ways of purchasing music using keywords inputed by the user or stored URLs transmitted through SCA data. The device used in conjunction with the invention allows users to store keywords onto a memory unit using a keypad and uses a display to show user input or stored memory items. A software program uses the data on the memory unit and a PC interface to the device to search key web servers for keywords or uses a specific URLs specified in the data to download the song directly to the user's PC after a purchase has been authorized by the user.

### BRIEF DESCRIPTION OF THE DRAWINGS

Drawing 100 is a perspective view of how the system will be used in relation to the user, radio stations, sponsored servers, and the artists.

Drawing 200 is an example of a possible form of the user interface for the device.

Drawing 300 is a basic overview of some of the components that maybe found in the invention.

### DETAILED DESCRIPTION OF THE INVENTION

This description is intended only to provide one possible embodiment of the proposed invention. The details that follow should not be interpreted as excluding the existence of additional embodiments that also incorporate the recited features.

Drawing 100 shows an overview of how the technology maybe used. When an Artist wishes to place their music online to sell they have three options, two of which are represented on Drawing 100.

The first method is to contact a radio station directly to sell their music. This will require the artist to submit the song they wish to sell to the radio station. The radio station will place the song on their servers 104 so it maybe purchased. When the song is played over the station, the SCA data broadcast ed at the same time as the song will contain the URL data from the Radio Station Server 104. This SCA data will be decoded, checked for integrity, and decrypted if necessary by a small hand held device 103. Later the Device 103 will be used in conjunction with software 102 on the user's home PC to communicate with the Radio station's server 104 via the Internet. The purchased will be placed according to whatever purchasing method has been established by the Radio Station Server 104. This purchase will then split the money made from the purchase and distribute it to the Radio station and the Artist.

The second method is in the case that there is no SCA data to record. When a User hears a song they like or wish to purchase, they can input keywords such as the artist name, song name, or song lyrics, into the Device 103 and store it for retrieval later. With the Software 102, the user can then use these keywords to communicate with Central Lookup Server 105. These servers are standard DNS names that will not change for the duration of the software's version is supported. The Central Lookup Servers 105 contain a large database of artists, band links, companies that sponsor bands through hosting online, and individual links for small time artists that do not have a public place to sell their music. The Central Lookup Servers 105 provide links to Sponsored Servers 101 in which the purchase of the music the user wants can be made. Payments are then divided among the parties responsible for placing the song online and the artist.

The third method is in the case that no keyword match can be found on the Central Lookup Servers 105. In this case the User's Software 102 will search preset websites on the Internet to purchase the music they are looking for. This may include Itunes, Amazon.com, Wal-Mart.com, or any website not supported by the Central Lookup Servers 105.

The next Drawing is of the User Interface for the Device 200. The Leds 203 will display the current mode of the device. Possible modes include, Purchase available, Searching for SCA data, Tuning, or Management. If SCA data has been detected and validated by the device a light will indicate this to the user. When this light is active the user may press the purchase button to store the URL data to the memory of the device. When the device has been tuned to a specific radio station, the device will indicate that it is searching for SCA data with a specific light. If the user has just entered a new radio station to tun to, the device will notify the user that it is processing their last request with another light.

The keypad 201 will include numbers and letters, possibly both on the same key as found on most phones. There will also be mode buttons on the keypad that allow the user to turn off the device, tune to a new station, enter keywords to store into the device, or manage the memory in the device.

The LCD screen 202 will display a variety of information to the user. It allows the user to view the data in the memory when they access it with the keypad 201. It will notify the user of any errors the device may have encountered during operation. The LCD 202 will also show the station currently tuned to.

The third drawing is a basic example of the components in the device 300. An SCA receiver 301 is used to scan the current station the device is tuned to in order to capture any URL data available. The data captured by the SCA receiver 301 will be decoded by an analog to digital converter 302. This ADC 302 will be activated when the correct signal has been received by the SCA receiver 301. Once the ADC 302 has been activated, it begins to store the URL data and any other data attached to the URL to the local buffer. A closing signal will notify the ADC to stop receiving data. The received messaged is decoded and checked for integrity 304. The ADC 302 is locked down from use until this data has been checked. If an error is generated while the data is being checked, an error is generated and displayed to the user through the user interface 303 (communication not shown on drawing). If the data is simply not valid it is thrown away and the buffer is cleared 304. The ADC 302 is then reactivated for the next signal to be received.

There are special SCA signals used to tell the ADC 302 if a new song is being played. At which moment the the buffer 304 moves the previous data in it to a long term storage area available in Memory 307 regardless if the user has pressed the purchase button or not 306. This is to allow the user to scroll through previously heard songs and select to purchase them later. The number of songs the user can scroll back through depends on the device memory capacity and how much has been allowed for such an action 307. This clearing of the buffer allows the ADC 302 to store URL data for the next song being played without prompting the user for interaction.

If no URL signal is identified by the SCA receiver 301, or no valid data is decoded by the ADC 302/304, then the user has the option of inputing keywords to store for searching later. The user will simply press a button on the user interface 303 that will allow them to add a new entry to the memory. As the user enters the data it is displayed on the LCD screen 303/202. This data likewise is stored into a buffer 305. When the user is ready to store the keyword(s) they press the store button 306 and the buffer 205 is transferred into the long term memory 307.

When the device is connect to a computer's USB port, the USB controller 308 will communicate with the Memory of the device 307 to retrieve any keywords or stored URLs the user has selected for purchasing/searching. This data is then used by the software in the manor described before.

While the invention has been described in terms of various specific embodiments, those skilled in the art will recognize that the invention can be practiced with modification within the spirit and scope of the claims.

What is claimed is:

1. A method for selling music using SCA data, said method comprising:
an SCA encoder capable of transmitting html URLs into an SCA frequency;
an SCA tuner capable of decoding a URL in SCA data;
a memory unit used in conjunction with the SCA tuner to store a list of URLs;
a user interface allowing a user to tune the SCA receiver;
a user interface allowing a user to manipulate the URLs stored in the memory unit;
an interface with the memory unit to communicate with a personal computer; and
a collection of computer instructions on a personal computer allowing a user to manage and utilize the data stored in the memory unit.

2. A method in accordance with claim 1 wherein the SCA encoder encrypts the URL data to be transmitted.

3. A method in accordance with claim 1 wherein said URLs transmitted are preceded by or followed by a hash used to determine data integrity of the transmission.

4. A method in accordance with claim 1 wherein the transmission combines the URL data with additional information about the URL.

5. A method in accordance with claim 1 wherein the SCA tuner is capable of tuning to multiple SCA channels in parallel.

6. A method in accordance with claim 1 wherein decoding of a URL is comprised of but not limited to an analog to digital converter and a series of components capable of checking the data integrity of the transmission.

7. A method in accordance with claim 1 wherein the computer instructions may search the Internet for a keyword stored in the memory unit.

8. A device for storing URLs in a memory unit received by an SCA tuner, said device comprises:
A keypad to store keywords chosen by the user as an alternative when no URL data is available;
A decoder or decryption system attached to the tuner;
A memory unit to store data;
A collection of LEDs or indicator lights to notify the user of the status of the device;
A display to provide additional information to the user;
A personal computer interface to allow data transfer from the memory unit or provide other administrative tasks of the device.

9. A device in accordance with claim 8 wherein said decoder or decryption system comprises but is not limited to a an analog to digital converter, a circuit to check integrity of the signal, and a circuit used to decode any encryption system in place.

10. A device in accordance with claim 8 wherein said keypad comprises but is not limited to an alpha-numeric interface with three letters and 1 number per key.

11. A device in accordance with claim 8 wherein said keypad comprises a purchase button to store information received by the SCA tuner or information inputed by the user through the keypad.

12. A device in accordance with claim 8 wherein said display comprises but is not limited to a standard LCD digital display.

13. A device in accordance with claim 8 wherein said computer interface comprises but is not limited to a USB controller.
